(19) United States
(12) Patent Application Publication
(10) Pub. No.: US 2011/0109297 A1
(43) Pub. Date: May 12, 2011

(54) PARALLEL AC SWITCHING WITH SEQUENTIAL CONTROL

(75) Inventor: Nam Tosuntikool, Hillsboro, OR (US)

(73) Assignee: LEVITON MANUFACTURING CO., INC., Melville, NY (US)

(21) Appl. No.: 12/615,172

(22) Filed: Nov. 9, 2009

(51) Int. Cl. H02J 3/12

(52) U.S. Cl. 323/350

(57) ABSTRACT

Parallel switches arranged to transfer power between an AC power source and a load may be individually operated during different portions of the AC waveform. In some embodiments, the switches may be operated during alternate cycles of the waveform to cause the individual switches to sequentially conduct the entire load current.

### BACKGROUND

FIG. 1 illustrates a prior art circuit for controlling the flow of AC power to a load. A Triac TR1 operates as an AC switch between a power source 12 and a load 14. A controller 16 can cause the Triac to operate two different modes. In one mode, the Triac operates as a simple on/off switch that conducts the maximum available AC power during the entire positive and negative line cycles of the AC power source.

In a second mode, as illustrated in FIG. 2, the Triac operates in a phase-control mode to regulate the amount of power transferred to the load. The voltage of the AC power source is shown as a broken line. An AC line cycle has a positive half cycle beginning at time t0 and ending at a midpoint zero crossing at t2. The AC line cycle then has a negative half cycle beginning at t2 ending at t4. At time t1, a switch is turned on to connect the power source to the load. The switch continues conducting during period T_{A} which is related to the conduction angle θ. The conduction angle is 180 degrees if the switch turns on at t0, 90 degrees if the switch turns on at the peak of the positive half cycle, and 0 degrees at time t2. At the zero cross at time t2, the switch turns off, either by itself in the case of a thyristor such as an SCR or Triac, or by action of a control signal in the case of a transistor. By varying the conduction angle, the average power delivered to the load may be varied. The greater the area of the solid waveform, the greater the percentage of power delivered to the load.

### BRIEF DESCRIPTION OF THE DRAWINGS

FIG. 1 illustrates a prior art circuit for controlling the flow of AC power to a load.

FIG. 2 illustrates a prior art phase control technique for controlling the flow of AC power to a load.

FIG. 3 illustrates a typical derating curve for a prior art Triac.

FIG. 4 illustrates a prior art circuit having parallel Triacs.

FIG. 5 illustrates a prior art heat sinking arrangement for parallel Triacs.

FIG. 6 illustrates an embodiment of a circuit according to some inventive principles of this patent disclosure.

FIG. 7 illustrates an example embodiment of a method according to some inventive principles of this patent disclosure.

FIG. 8 illustrates another example embodiment of a method according to some inventive principles of this patent disclosure.

FIG. 9 illustrates another embodiment of a circuit according to some inventive principles of this patent disclosure.

FIG. 10 illustrates an example embodiment of a method for operating the circuit of FIG. 9 according to some inventive principles of this patent disclosure.

FIG. 11 illustrates another embodiment of a circuit according to some inventive principles of this patent disclosure.

FIG. 12 illustrates an example embodiment of a method for operating the circuit of FIG. 11 according to some inventive principles of this patent disclosure.

FIG. 13 illustrates an embodiment of a wiring device according to some inventive principles of this patent disclosure.

FIG. 14 illustrates a cross-sectional view of another embodiment of a wiring device according to some inventive principles of this patent disclosure.

FIG. 15 illustrates a cross-sectional view of another embodiment of a wiring device according to some inventive principles of this patent disclosure.

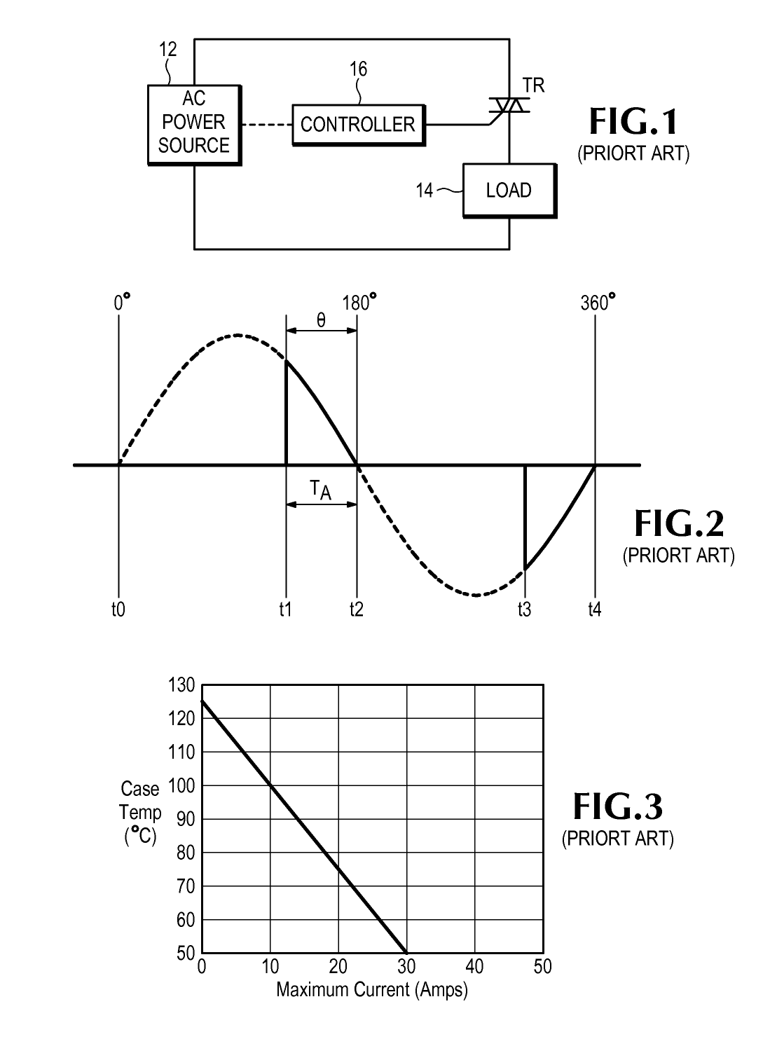

### DETAILED DESCRIPTION

Every power switch has a maximum amount of current it can conduct. As the temperature of the switch increases, the maximum allowable switch current decreases. Thus, a power switch must be derated based on the maximum anticipated operating temperature. That is, a switch that may be able to conduct a large amount of current at a normal operating temperature may be used in a circuit in which it will switch much lower currents to improve reliability when operating at higher temperatures. Derating a switch for operation at elevated temperatures typically increases the cost of the switch.

The maximum current ratings of semiconductor switches such as transistors, Triacs, SCRs, etc. are especially sensitive to elevated temperatures. FIG. 3 illustrates a derating curve showing how the maximum amount of conduction current for an example Triac varies over a range of case temperatures. At a case temperature of 50° C., the Triac can conduct 30 Amps. As the case temperature increases, however, the maximum allowable current steadily decreases. By the time the case temperature reaches 100° C., the current rating is reduced to 10 Amps, which is only one-third of its rating at 50° C. Other semiconductor switches such as transistors, SCRs, etc. suffer from similar derating problems.

Thus, to design a circuit with a switch that is capable of switching 30 Amps at 100° C., a larger Triac must be used, or the temperature of the Triac must be reduced. Using a larger Triac may be prohibitively expensive, or in some cases, a large enough Triac may simply be unavailable. Reducing the operating temperature of the Triac typically involves mounting the Triac to a heat sink which may be bulky, time consuming, and/or prohibitively expensive in terms of both material costs as well as assembly costs.

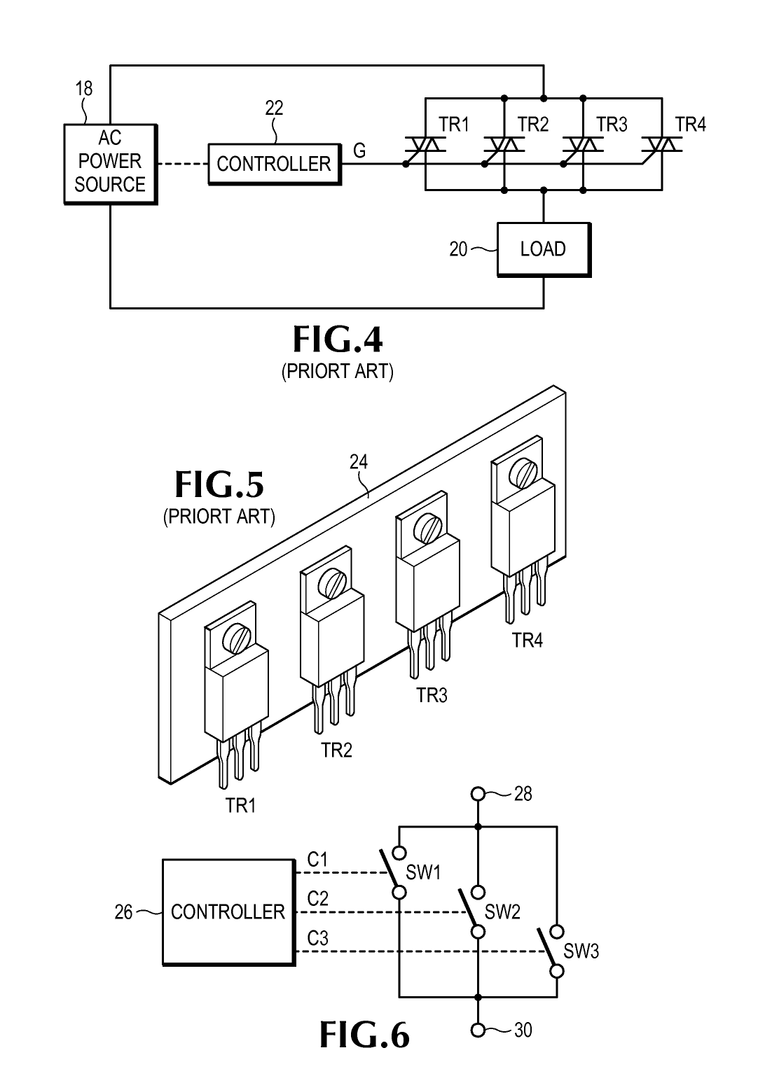

One approach to increasing the current handling capacity of a semiconductor switch involves the use of multiple devices connected in parallel as shown in FIG. 4. The main terminals of four Triacs TR1-TR4 are connected in parallel, and their gate terminals are all triggered simultaneously by a single gate signal G. To further increase the current rating, the Triacs may be mounted to a common heat sink 24 as shown in FIG. 5.

In a parallel configuration, the total load current I_{L}=I₁+I₂+ . . . +I_{N}, where N is the total number of switches and Iₙ is the current through each device. For a single device, the power dissipation P=I_{L}·VT, where VT is the on-state voltage drop across the device. For multiple parallel devices, the total power dissipation P=(I₁·VT₁)+(I₂·VT₂)+ . . . +(I_{N}·VT_{N})=I_{L}·VT_{N}. However, VT_{N} is lower than VT since Iₙ is equal to I_{L}/N. Therefore, the power dissipation of each individual parallel device is lower than the power dissipation in the one device used for a single device configuration. Lower power dissipation yields lower device junction temperatures and enhanced current drive capability.

In theory, the approach illustrated in FIG. 4 may provide a switch having four times the current rating of the individual devices. In a practical implementation, however, various factors may introduce imbalances that prevent the circuit configuration of FIG. 4 from achieving the intended current rating. For example, all of the Triacs must be well matched in terms of on-state voltage drop, electrical resistance, thermal resistance, gate trigger voltage, etc. Otherwise, one or more of the devices may begin conducting more current than the other devices—a condition sometimes referred to as “hogging” current. This may result in elevated junction temperatures which cause further current imbalances, and/or the failure of one or more devices. To compensate for these imbalances, the combined switch may need to be derated to a current level that is well below four times the current rating of the individual devices, thereby sacrificing much of the intended benefit of the parallel configuration.

Obtaining devices with matched characteristics may itself be problematic. This may require obtaining devices from the same manufacturer and/or production lot, thereby complicating the manufacturing process and supply chain and preventing the mixing of devices from lowest cost sources. Even devices from the same manufacturing lot may have unacceptable variations, thereby necessitating testing and sorting the devices which further increases complexity and cost.

Imbalances in the heat sinking of each device also conspire to prevent the circuit configuration of FIG. 4 from achieving the intended current rating. A large heat sink may be required to provide enough thermal mass to equalize the case and junction temperatures of the devices. Any differences in the relative tightening torque (or attachment force), amount of heat sink compound, etc., between the individual devices may cause uneven operating temperatures and/or imbalances in current conduction. Multiple parallel devices also tend to be sensitive to the physical arrangement of the devices on the heat sink, thereby requiring complex layout patterns that are difficult and expensive to manufacture.

FIG. 6 illustrates an embodiment of a circuit according to some inventive principles of this patent disclosure. In the embodiment of FIG. 6, two or more switches are arranged in parallel between terminals 28 and 30. In this example, three switches SW1-SW3 are illustrated, but any combination of two or more switches may be used. The embodiment of FIG. 6 may be connected in a circuit in any suitable manner to enable the parallel switches to transfer power between an AC power source and a load. A controller 26 generates control signals C1-C3 to provide individual control of the switches so that the individual switches may operate during different portions of the AC waveform. For example, the controller may operate the switches sequentially during alternating cycles or half-cycles of the AC waveform.

The switches may be implemented with Triacs, silicon controlled rectifiers (SCRs) in parallel or anti-parallel arrangements, transistors, gate turn-off (GTO) thyristors, tubes, solid state relays, optoelectronic devices, magnetic devices, or any other switches suitable for operating during different portions of an AC waveform. The controller may be implemented with analog or digital hardware, software, firmware, or any suitable combination thereof. In some embodiments, the controller may include a microcontroller or other form of microprocessor which generates the control signals. The patterns of control signals may be stored in lookup tables, generated through mathematical algorithms, or derived in any other suitable manner.

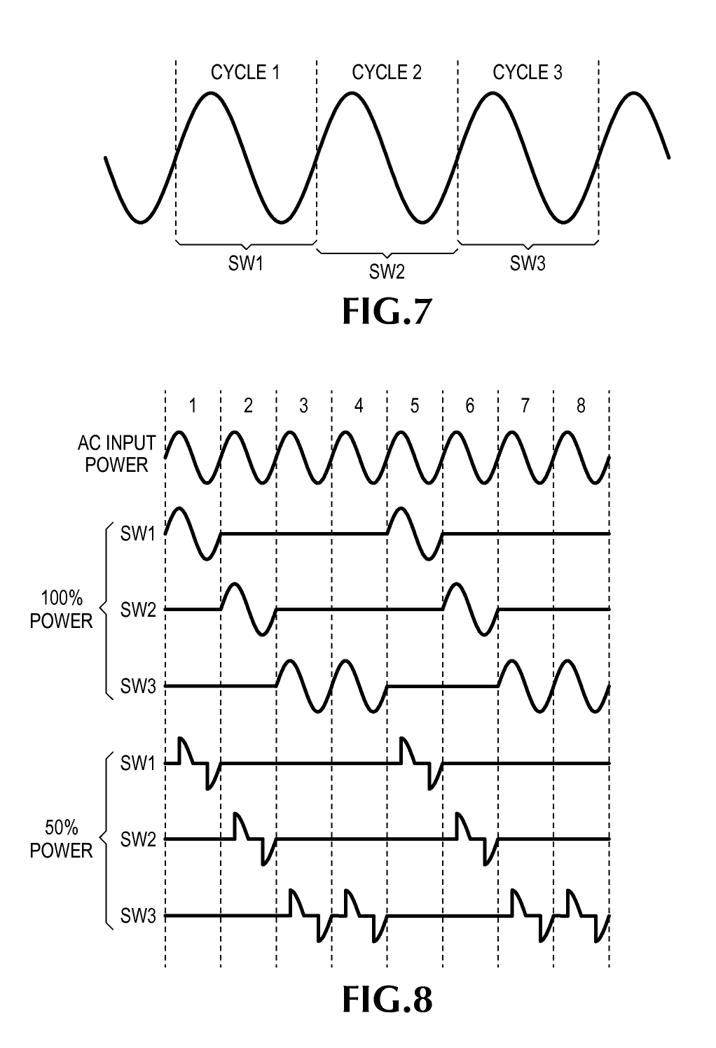

FIG. 7 illustrates an example embodiment of a method in which three parallel switches are controlled individually during different portions of an AC waveform according to some inventive principles of this patent disclosure. During cycle 1, a first switch SW1 is used to control the flow of power from an AC power source and a load. This may include turning the switch on for the entire cycle, turning it on during a portion of each half-cycle as in a phase control technique, turning it on only during all or a portion of one half-cycle, turning it on during multiple portions of the cycle or half-cycle, etc. During cycle 2, a second switch SW2 is used to control the flow of power from the AC power source and a load. As with SW1 during cycle 1, SW2 may be turned on for the entire second cycle, for a portion of each half-cycle, etc. During cycle 3, a third switch SW3 operates to control the AC power to the load. The pattern repeats again beginning with cycle 4, during which the first switch SW1 once again controls the AC power to the load. During cycles 5 and 6, switches SW2 and SW3 are operated, respectively.

FIG. 8 illustrates an example embodiment of a method in which the three parallel switches shown in FIG. 6 are used to transfer power from an AC source to a load according to some inventive principles of this patent disclosure. The embodiment of FIG. 8 implements a phase control technique in which the amount of power transferred to the load is controlled by the conduction angle of the switches. The top trace illustrates the waveform of the power from the AC power source.

The next three traces illustrate the operation of the three switches when 100 percent of the available power is transferred to the load. The traces SW1, SW2 and SW3 illustrate the voltage waveforms applied to the load by the first, second and third switches, respectively. During cycle 1, the first switch SW1 is turned on during the entire 180 degrees of each of the positive and negative half cycles. During cycle 2, the second switch SW2 is turned on during the entire positive and negative half cycles. During cycle 3, the third switch SW3 is turned on during the entire positive and negative half cycles. During cycle 4, the third switch is again turned on during the entire positive and negative half cycles. This cycle of four patterns is then repeated. Alternatively, the double cycle of switch SW3 could be rotated through switches SW1 and SW2 during subsequent four-cycle patterns.

The lowest three traces illustrate the operation of the three switches when 50 percent of the available power is transferred to the load. During cycle 1, the first switch SW1 is turned on during the last half (90 degrees) of each of the positive and negative half cycles. During cycle 2, the second switch SW2 is turned on during the last half of each of the positive and negative half cycles. During cycle 3, the third switch SW3 is turned on during the last half of each of the positive and negative half cycles. During cycle 4, the third switch is again turned on during the last half of each of the positive and negative half cycles. This cycle of four patterns is then repeated. Alternatively, the double cycle of switch SW3 could be rotated through switches SW1 and SW2 during subsequent four-cycle patterns.

In the examples of FIG. 8, switches SW1 and SW2 are each turned on during 25 percent of the total on time, and switch SW3 is turned on during 50 percent of the total on time. Therefore, switches SW1 and SW2 each dissipate 25 percent of the total switch heat, while switch SW3 dissipates 50 percent. These examples illustrate some of the potential benefits of the various inventive principles of this patent disclosure. For example, by operating multiple parallel switches sequentially, the percentage power dissipation of any one switch may generally be equal to its percentage of the total on time. Therefore, its junction temperature may be reduced accordingly.

The junction temperature (Tj) of each device is Tj=Ta+Rja·P, where Ta is the ambient temperature, Rja is the thermal resistance between the device junction and its ambient environment, and P is the power dissipation of the device. Since the power dissipation of each device may be equal to its on-time percentage times the total power dissipation, the Tj for each device may be controlled by scaling its percentage of the operating time.

Moreover, the switches may not need to be matched. In some embodiments, parallel switches with widely disparate characteristics may be used because the sequential operation may assure that no one switch will conduct more current than the other switches. In embodiments with no overlap between switches, the full load current must necessarily flow through each switch during its corresponding portion of the AC waveform, regardless of its on-state voltage drop, electrical resistance, thermal resistance, gate trigger voltage, etc. Thus, concerns over uneven current distribution (hogging) between parallel devices may be eliminated.

As a further example, some of the inventive principles may eliminate the need for parallel devices to be mounted to a common heat sink and/or may eliminate the need for a heat sink for all or some of the devices and/or may simplify heat sinking arrangements. Additionally, some of the inventive principles may enable a circuit to steer more instantaneous or average current through one or more of the parallel devices. For example, in some implementations, space constraints may permit only one of the parallel switching devices to be attached to a heat sink. By using a switching sequence similar to the one illustrated in FIG. 8 and attaching switch SW3 to a heat sink, the device with better thermal dissipation capacity (SW3) may handle 50 percent of the total current, while switches SW1 and SW2 only need to handle 25 percent each, and thus, may be able to operate without heat sinks. Alternatively, a mixture of large and small switches may be arranged in parallel and their respective on-time percentages may be adjusted accordingly.

Countless variations of implementation details are contemplated in accordance with the inventive principles of this patent disclosure. For example, even though there is no overlap between switches in the embodiments described above, other embodiments of sequential switching techniques may include some overlap between the on times of some of the switches according to some inventive principles of this patent disclosure. As a further example, sequential time slices for each switch may be divided between half-cycles rather than full cycles or multiple full cycles. In some other embodiments, one or more switches may be turned on during multiple portions of a single cycle, half-cycle or portion thereof, with or without overlap.

As yet another example, the inventive principles are not limited to purely AC loads. Thus, parallel switches with individual control may be arranged in a rectifying arrangement where AC power is converted to DC power, AC power with a DC offset, etc., while the individual parallel switches are being operated during different portions of the AC waveform.

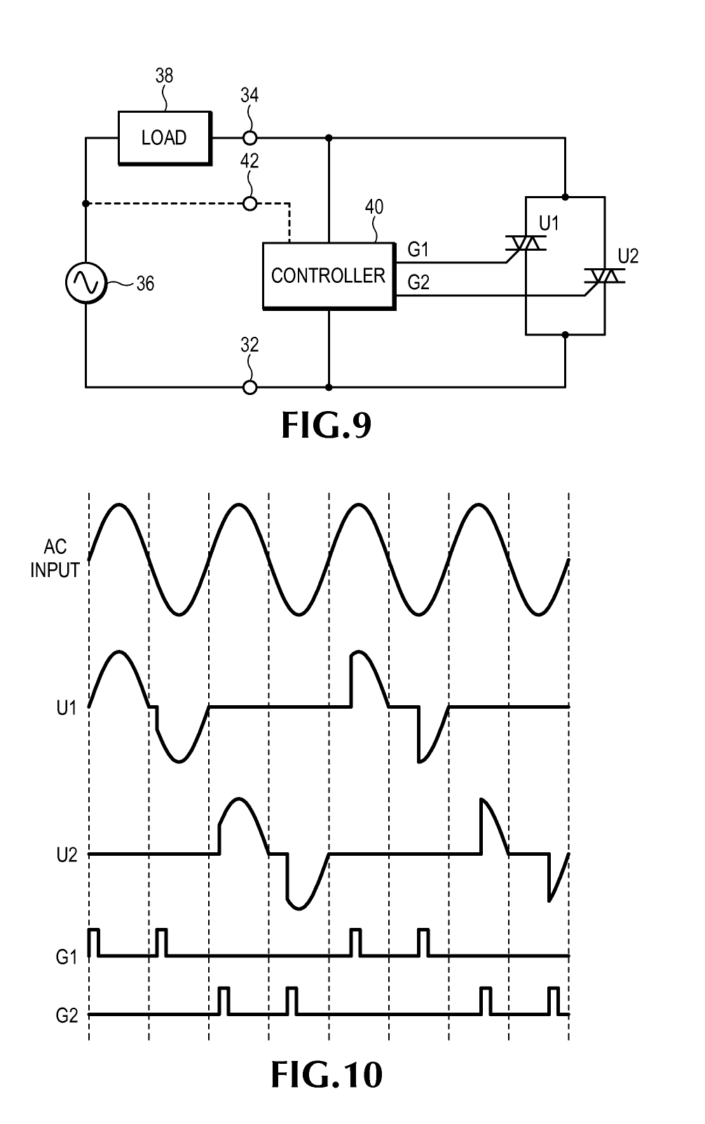

FIG. 9 illustrates another embodiment of a circuit according to some inventive principles of this patent disclosure. The embodiment of FIG. 9 includes two parallel Triacs U1 and U2. The main terminals of U1 and U2 are connected between neutral terminals 32 and a load terminal 34 to control the flow of power between an AC power source 36 and a load 38. A controller 40 is arranged to monitor, and receive power from, the AC waveform across terminals 32 and 34, and generate gate signals G1 and G2 to individually trigger Triacs U1 and U2. In some embodiments, the controller 40 may include enough energy storage to continue operating during which one of the switches is on, thereby reducing voltage across the neutral and load terminals 32 and 34 to a very low level. In other embodiments, a hot terminal 42 may provide a direct connection to the AC power source to enable better monitoring of the AC waveform and uninterrupted power to the controller.

FIG. 10 illustrates an example embodiment of a method for operating the system of FIG. 9 according to some inventive principles of this patent disclosure. The top trace shows the waveform of the AC input power. The traces labeled U1 and U2 show the waveform of the power applied to the load by Triacs U1 and U2, respectively, while G1 and G2 show the gate pulses generated by the controller 40 to operate U1 and U2. In this example, the system is shown making a transition from a 180 degree conduction angle to about a 55 degree conduction angle over the course of four line cycles.

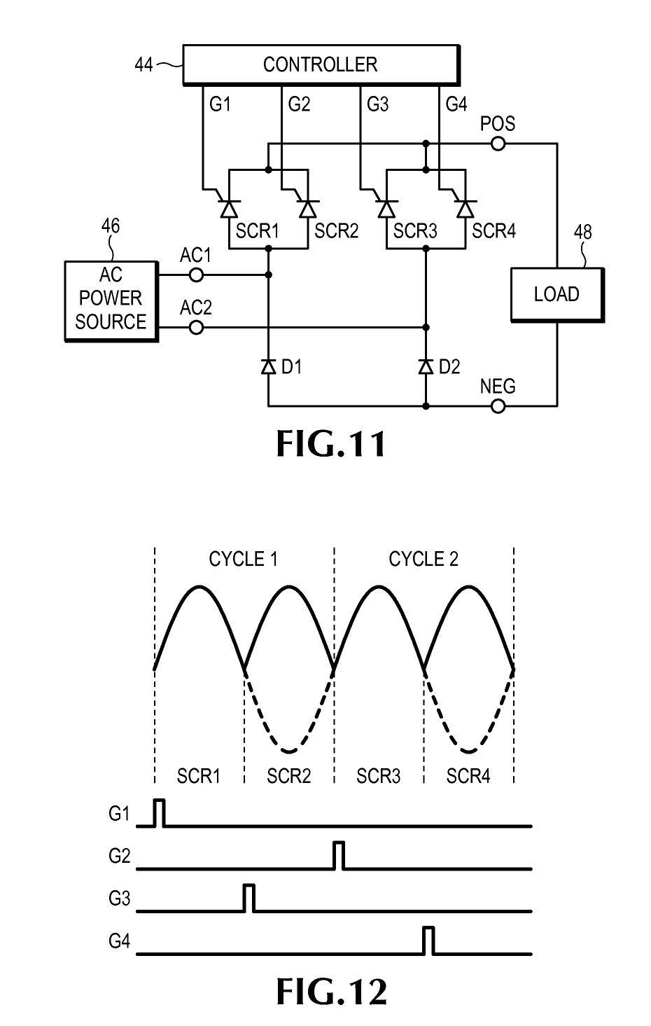

FIG. 11 illustrates another embodiment of a circuit according to some inventive principles of this patent disclosure. The embodiment of FIG. 11 includes a rectifier bridge in which two silicon controlled rectifiers SCR1 and SCR2 are arranged in parallel between a first AC input terminal AC1 and a first DC output terminal POS. Two more SCRs SCR3 and SCR4 are arranged in parallel between a second AC input terminal AC2 and a second DC output terminal NEG. Diodes D1 and D2 complete the bridge, although additional SCRs or parallel combinations of SCRs could be used instead.

A controller 44 generates gate signals G1-G4 to enable SCR1-SCR4 to control the flow of power from an AC source 46 to a DC load 48. The controller 44 can operate SCR1 and SCR2 individually during different portions of the AC waveform. Likewise, the controller can operate SCR3 and SCR4 individually during different portions of the AC waveform. Thus, the individual SCRs in the parallel combinations do not need to be matched, and the potential benefits described above in the context of the embodiments of FIGS. 6-10 may be applicable.

FIG. 12 illustrates an example embodiment of a method for operating the system of FIG. 11 according to some inventive principles of this patent disclosure. The solid trace shows the output voltage from the bridge, assuming the load is purely resistive. The broken trace shows the AC waveform during negative half cycles. During the first half of cycle 1, SCR1 and D2 deliver the entire first half-cycle of power to the load. During the second half of cycle 1, SCR3 and D1 deliver the entire second half-cycle of power to the load. During the first half of cycle 2, SCR2 and D2 deliver the entire first half-cycle of power to the load. During the second half of cycle 2, SCR4 and D1 deliver the entire second half-cycle of power to the load.

The embodiment of FIG. 12 is illustrated with full half-cycle (180 degree) conduction, but the controller 44 could also gate the SCRs at other conduction angles to provide rectifying phase control of the output power.

Although the inventive principles of this patent disclosure are not limited to any particular application, some of the inventive principles may be especially useful when applied to wiring devices such as, for example, switches, timers, motor controls and/or dimmers where the devices must fit into the limited space available in standard electrical wall boxes, or in power packs.

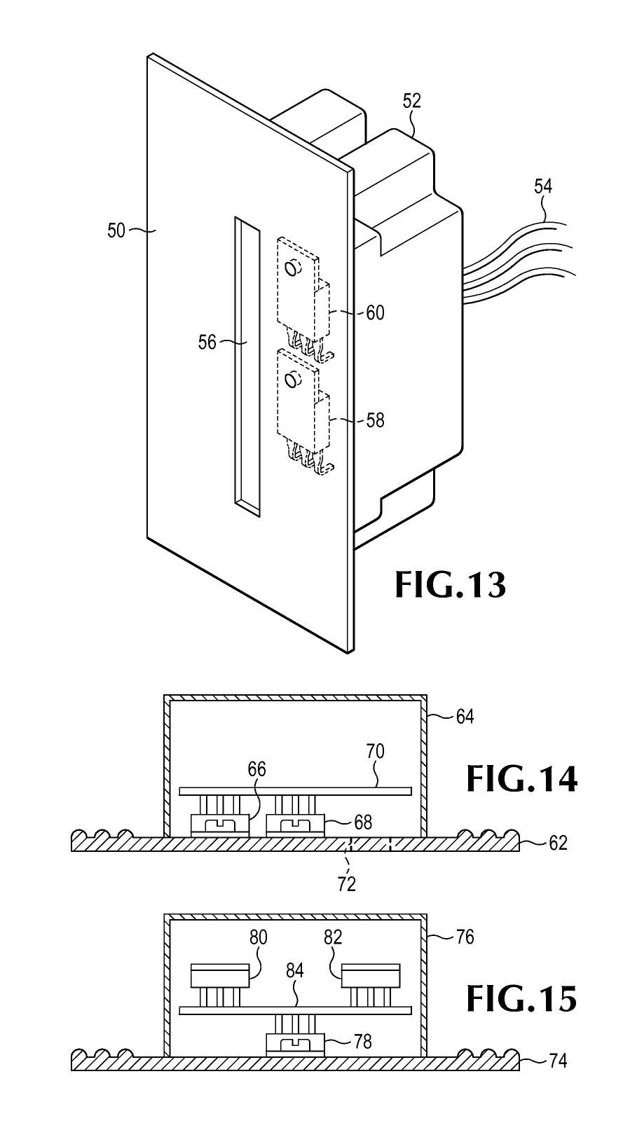

FIG. 13 illustrates an embodiment of a wiring device according to some inventive principles of this patent disclosure. The embodiment of FIG. 13 includes a faceplate 50 that functions as a mounting strap for the wiring device, as well as a heat sink for one or more power switches. A housing 52 encloses the internal circuitry, while wire leads 54 or other forms of connections enable the wiring device to be connected to building wiring. The example embodiment of FIG. 13 is shown as a dimmer, but the inventive principles are applicable to other types of wiring devices. The faceplate 50 includes a cutout 56 for a dimmer slide switch to enable a user to adjust the amount of AC power transferred to the load. Two or more parallel switches 58-60 are shown in outline form attached to the back of the faceplate. The housing 52 may enclose one or more circuit boards, modules, processors, and/or other components to enable the wiring device to transfer power between an AC power source and a load by operating the switches during different portions of the AC waveform.

In the embodiment of FIG. 13, the switches are mounted at different, asymmetric locations on the faceplate and, therefore, they may have different cooling capacities. By operating the parallel switches during different portions of the AC waveform, for example, sequentially during alternate full cycles, any current imbalances caused by unequal heat relief to the switches may be rendered harmless according to some inventive principles of this patent disclosure.

FIG. 14 illustrates a cross-sectional view of another embodiment of a wiring device according to some inventive principles of this patent disclosure. The embodiment of FIG. 14 includes a faceplate/heat sink 62 and housing 64. Two Triacs or other switches 66-68 are connected in parallel and mounted to the faceplate/heat sink and controlled individually by a microcontroller or other circuitry on a circuit board 70. The faceplate/heat sink 62 may include one or more apertures 72 to accommodate switches, buttons, slides, lights, dials and/or other user inputs and/or outputs. The circuit board and switches are configured to enable the wiring device to transfer power between an AC power source and a load by operating the switches during different portions of the AC waveform. By operating the parallel switches during different portions of the AC waveform, for example, sequentially during alternate full cycles, any current imbalances caused by unequal heat relief to the switches or mismatches in the switches may be rendered harmless according to some inventive principles of this patent disclosure.

FIG. 15 illustrates a cross-sectional view of another embodiment of a wiring device according to some inventive principles of this patent disclosure. The embodiment of FIG. 15 includes a faceplate/heat sink 74 and housing 76. One or more Triacs or other switches 78 are mounted to the faceplate/heat sink and controlled by a microcontroller or other circuitry on a circuit board 84. One or more other Triacs or other switches 80-82 are also controlled by the circuit board 84, but the cases of these switches are exposed to free air and/or potting material inside the housing, and/or mounted to one or more separate heat sinks. All of the switches 78-82 may be connected in parallel, but individually controllable by the circuit board. The circuit board and switches are configured to enable the wiring device to transfer power between an AC power source and a load by operating the switches during different portions of the AC waveform. The faceplate/heat sink 74 may also include one or more apertures to accommodate switches, buttons, slides, lights, dials and/or other user inputs and/or outputs. By operating the parallel switches during different portions of the AC waveform, for example, sequentially during alternate full cycles, any current imbalances caused by unequal heat relief to the switches or mismatches in the switches may be rendered harmless according to some inventive principles of this patent disclosure.

In some embodiments, parallel switches with individual control may each need to be capable of carrying more instantaneous current than in an arrangement with simultaneous control. However, this may be fully or partially offset by lower duty cycle rating, lower average current rating, and other factors such as more cooling time between conduction periods, etc., according to some inventive principles of this patent disclosure.

In some embodiments, the inventive principles described above may be implemented in a form factor suitable for use in an energy management and/or building automation system such as a system having a central distribution panel with modules for lighting control, fan control, etc. In yet other embodiments, the inventive principles may be realized in the form of a power pack where all or most of the components are located in a power pack housing, and a remote connection is provided for the speed selection input. For example, a low voltage (e.g. 24 volt DC) switch or digital switch may be used to provide control input to the power pack, from where the parallel switches with sequential control may control a load wired to the power pack.

In some embodiments, the inventive principles may be adapted to control heaters, pumps, actuators, lights and/or any other type of electrical load. Moreover, such a system may be implemented in a form factor other than a wiring device, for example, as a module for a panel, as a power pack, etc.

Any of the control circuitry and logic described and claimed herein may be implemented in analog and/or digital hardware, software, firmware, etc., or any combination thereof. The inventive principles may be applied to systems for interior, exterior or hybrid building spaces.

The inventive principles of this patent disclosure have been described above with reference to some specific example embodiments, but these embodiments can be modified in arrangement and detail without departing from the inventive concepts. For example, some embodiments have been illustrated in the context of single-phase AC power systems, but the inventive principles may also be applied to system employing three-phase and other forms of AC power. As another example, some embodiments have been illustrated with directed connections from a controller to the gates of switching devices. In other embodiments, however, gate signals and other control signals may be isolated though optocouplers, magnetic transformers, etc. Some embodiments have been illustrated with Triacs and SCRs, but the inventive principles may be applied to systems using any suitable types of switching devices. Thus, any changes and modifications are considered to fall within the scope of the following claims.

1. A system comprising:
a first switch to transfer power between an AC power source and a load;
a second switch coupled in parallel with the first switch; and
a controller to operate the first and second switches during different portions of a waveform of the AC power source.

2. The system of claim 1 where the first and second switches may be turned on sequentially.

3. The system of claim 2 where the first and second switches may be turned on for substantially complete cycles of the AC power.

4. The system of claim 2 where the first and second switches may be turned on for substantially complete half-cycles of the AC power.

5. The system of claim 2 where the first and second switches may be turned on for one or more portions of cycles of the AC power.

6. The system of claim 2 where the first and second switches may be turned on for one or more portions of half-cycles of the AC power.

7. The system of claim 2 where the first and second switches comprise Triacs.

8. The system of claim 2 where each of the first and second switches comprise two anti-parallel SCRs.

9. The system of claim 2 where each of the first and second switches comprise two parallel SCRs.

10. The system of claim 2 where the first and second switches are arranged in a rectifying bridge.

11. The system of claim 2 where the first and second switches may be operated to provide phase control.

12. The system of claim 2 where the first switch may operate during a first cycle of the AC power and operate the second switch may operate during a second cycle of the AC power.

13. The system of claim 2 where the load comprises an AC load.

14. The system of claim 2 where the load comprises a DC load.

15. The system of claim 2 where the first and second switches may be turned on during alternate cycles of the AC power.

16. The system of claim 2 where the first and second switches may be turned on during alternate half cycles of the AC power.

17. The system of claim 1 further comprising a third switch coupled in parallel with the first switch, where the controller is to operate the first, second and third switches during different portions of a waveform of the AC power source.

18. The system of claim 1 where the different portions of the waveform partially overlap.

19. A method comprising:
operating first and second switches coupled in parallel between an AC power source and a load;
where the first and second switches are operated during different portions of a waveform of the AC power source.

20. The method of claim 19 where the first and second switches are operated sequentially.

21. The method of claim 20 where the first and second switches are turned on during alternate cycles of the AC power.

22. The method of claim 20 where the first and second switches are turned on during alternate half-cycles of the AC power.

23. The method of claim 20 further comprising operating the first and second switches to provide phase control.

24. The method of claim 20 further comprising operating the first and second switches to rectify the AC power.

25. A controller comprising:
first and second sense terminals to sense the waveform of an AC power source;
a first control terminal to control a first switch;
a second control terminal to control a second switch that may be coupled in parallel with the first switch to transfer power between the AC power source and a load; and
control circuitry to operate the first and second switches during different portions of a waveform of the AC power source.

26. The controller of claim 25 where the control circuitry may operate the first and second switches sequentially.

27. The controller of claim 26 where the control circuitry may turn the first and second switches on during alternate cycles of the AC power source.

28. A wiring device comprising:
a first terminal to connect the wiring device to building wiring;
a second terminal to connect the wiring device to building wiring;
a first switch coupled between the first and second terminals to transfer AC power between the first and second terminals;
a second switch coupled in parallel with the first switch; and
a controller to operate the first and second switches sequentially during alternate cycles of the AC power.

29. The wiring device of claim 28 further comprising a heat sink thermally coupled to one or more of the first and second switches.

30. The wiring device of claim 29 where the heat sink comprises a faceplate.

31. The wiring device of claim 30 where the wiring device is constructed to fit in a standard electrical wall box.
